(19) United States
(12) Patent Application Publication
(10) Pub. No.: US 2002/0128802 A1
(43) Pub. Date: Sep. 12, 2002

(54) System for and method of remotely validating a rule set

(76) Inventor: Lewis Rompala, Spicewood, TX (US)

Correspondence Address: CHOATE, HALL & STEWART, 53 State Street, Exchange Place, Boston, MA, 02109, US

(21) Appl. No.: 09/802,028

(22) Filed: Mar. 8, 2001

(51) Int. Cl. G06F 15/00

(52) U.S. Cl. 702/188; 709/200

(57) ABSTRACT

A method of and system for remotely validating a rule set for a data transformation. The system includes a first computer remotely located from a customer site. The first computer is adapted to allow a user to enter test data, is configured with communications software, and is electrically connected, preferably by a network such as the Internet, to a server operating a trainable user interface translator application. The server is electrically connected to a local area network and a customer computer operating a host application that is involved in a data transformation. The user then may use the first computer and communications software to transmit test data and special keystroke data to the trainable user interface translator application, which in turn exercises the host application and data transformation and feeds results back to the user, thereby validating the rule set of the data transformation.

### FIELD OF THE INVENTION

The present invention is a system for and method of remotely validating a rule set for a data transformation. The method includes a form for documenting the validation testing. The invention has potential applications in the fields of software testing and quality assurance.

### BACKGROUND OF THE INVENTION

Quality assurance (QA) testing for computer applications is designed to guarantee a high-quality product. Customers want to know that they are receiving a reliable product that has been checked to a consistent and measurable level of quality. Customer satisfaction is also a critical factor in acquiring positive testimonials from customers, and in acquiring repeat business with customers. Effective QA testing boosts the likelihood of both.

Currently, no standard way exists to test a data transformation. Data transformation specifications and rule sets are not well validated under current QA methods. Without standardized QA methods, data transformation consistency and quality cannot be guaranteed. In addition, a lack of assessment standards prevents a data transformation company from accurately estimating the time and cost needed to perform QA testing. What is needed is a way to ensure a standard of quality control has been met.

A systematic process for QA testing helps to deliver a close-to-perfect data transformation to the customer, and thus satisfies the customer more completely. Current technology requires that QA testing be conducted at the customer site, resulting in additional travel and labor cost. By remotely conducting a standardized QA testing process, a data transformation company can add efficiency to, and reduce the cost of their QA testing. A complete and consistent QA process leads to a more robust product. What is needed is a way to more efficiently perform the QA process for a data transformation process.

Current QA methods provide neither consistent standards nor documentation of the QA process. Customers need proof of QA testing that can be provided to regulators, and need an efficient process to address errors in the data transformation process. What is needed is a way to increase customer satisfaction with data transformation products.

Current methods of QA testing are not repeatable and often have no consistent documentation requirements. These QA testing methods are often complex and therefore difficult to teach to new employees. What is needed is a way to facilitate staff training to perform a QA process.

Conventional QA methods do not include consistent documentation, and consistent standards are not always applied from project to project. Certain organizations such as the International Organization for Standardization (ISO) and the U.S. Food and Drug Administration (FDA) require consistency in QA processes performed and proof of QA test completion. What is needed is a way to document completion of a QA test of a data transformation.

Current methods for QA testing may not have a clear termination point. It is not always clear when QA testing for software is complete and warrants invoicing a customer. What is needed is a way to know when to bill a customer.

One approach to solving several of the problems described above is to perform random testing on a program. However, random testing may not give provide full testing coverage. Some validation tools exist which could be used to validate a rule set for a data transaction. However, other validation tools are not as cost effective as the present invention, nor do they build upon the teachings of U.S. Pat. Nos. 5,627,977 and 5,889,516 directed to a “trainable user interface translator”, which are assigned to the assignee of the present application.

### SUMMARY OF THE INVENTION

In one aspect, the present invention is a system for remotely validating a rule set for a data transformation. Such a system may include a first computer remotely located from a customer site. The first computer is adapted to allow a user to enter test data and is configured with communications software, which could be Procomm [symbol] . The first computer is electrically connected, preferably by a network such as the Internet, to a Teleshaper server operating a Teleshaper application. The “TeleShaper” terminology used herein to describe elements of the present invention preferably refers to an embodiment of a trainable user interface translator, as taught in the assignee's U.S. Pat. Nos. 5,627,977 and 5,889,516. The teachings of the assignee's patents are herein incorporated by reference, however the present invention is not limited in function or structure to those functions or structures recited in the assignee's prior patents. The Teleshaper server is also electrically connected to a local area network and a customer computer operating a host application involved in a data transformation. A user of the first computer and communications software may transmit test data and special keystroke data to the TeleShaper application, which in turn exercises the host application and data transformation and feeds results back to the user.

In another aspect, the present invention is a method of remotely validating a rule set for a data transformation. The method preferably begins with the step of receiving from a customer test data for validating a data transformation. Next, the user uses a subset of good (non-exception and non-error) test data to ensure that the data transformation functions as expected. In a similar fashion, the user then validates that the data transformation responses are appropriate in response to error and exception data and to special keystroke data. The user then ensures that a “master escape key” allows the customer an appropriate exit and reset from every input screen. The user also tests a timeout subroutine to ensure the system can recover from unexpected data entries.

### BRIEF DESCRIPTION OF THE DRAWINGS

FIG. 1 is a schematic diagram illustrating a system for remotely validating a rule set for a data transformation.

FIG. 2 is a flow diagram illustrating the steps of a method of remotely validating a rule set.

FIG. 3 is an embodiment of a quality assurance form for documenting the validation of a rule set.

### DETAILED DESCRIPTION

Preferred embodiments of the invention will now be described with reference to the accompanying drawings.

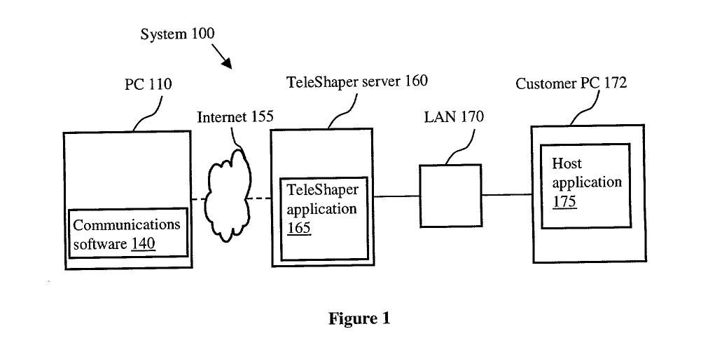

In one aspect, the present invention is a system for remotely validating a rule set for a data transformation, such as system 100 shown in FIG. 1. System 100 includes a personal computer (PC) 110, which contains communications software 140. In a preferred embodiment, PC 110 uses Microsoft™ Windows 98 as its operating system and uses Procomm™ as communications software 140.

PC 110 may also use the Internet 155 (or other network) and/or a telephone line (not shown) to connect to a customer site via a TeleShaper server 160, which is electrically connected to a local area network (LAN) 170. LAN 170 is, in turn, electrically connected to a customer PC 172, which contains a host application 175. TeleShaper server 160 operates a TeleShaper application 165.

In operation, a user of PC 110 uses communications software 140 to access TeleShaper application 165 via LAN 170. The user tests data transformation of the customer PC 172 by using TeleShaper application 165 to communicate with customer PC 172 and operate host application 175 via LAN 170.

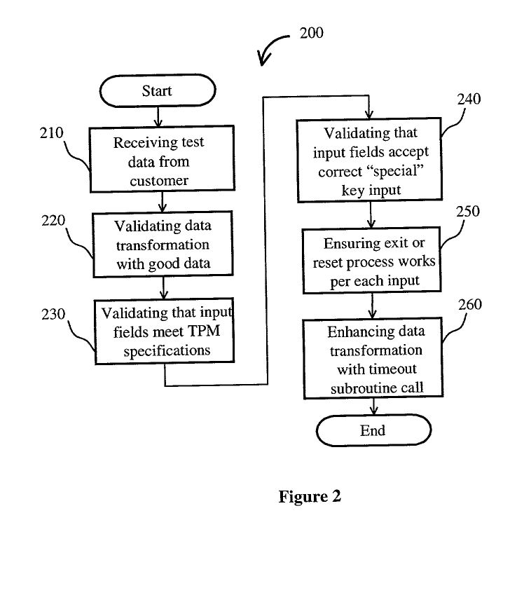

In another aspect, the present invention is a method for remotely validating a rule set. FIG. 2 is a flow chart showing a process 200 for remotely validating a rule set, and includes the following steps:

Step 210: Receiving Test Data from Customer

In this step, a customer provides a set of test data to the user for validation. To fully exercise the host application, the test data should include a complete representation of the input data ranges that will be entered. This includes good (non-error and non-exception) data, error data, and exception data. The data may be provided to the user in hard copy or electronic format, via methods including fax, phone, or e-mail.

Step 220: Validating Transformation Data with Good Data

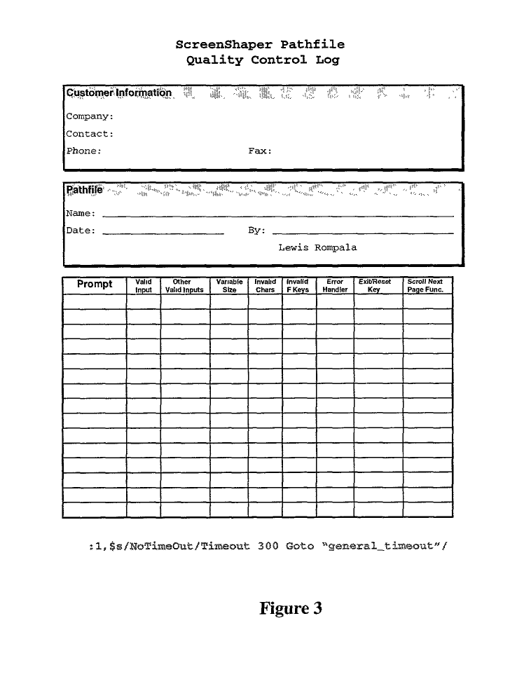

In this step, the user validates the transformation data with good (non-error and non-exception) data, which is a subset of the test data provided in step 210, using a pre-designed QA form shown in FIG. 3. The user completes the form using all the appropriate inputs according to the customer data transformation. The user tests each input field and enters the provided test data to ensure that the data transformation functions as expected. To perform the validation, the user communicates to TeleShaper application 165 by using communications software 140 via the Internet 155 (or other network). TeleShaper application 165 in turn communicates with customer PC 172 to operate host application 175 via LAN 170 and responds back to PC 110.

Step 230: Validating that Input Fields Meet TPM Specifications

In this step, the user checks to ensure that the data transformation meets the design specifications according to the targeted procedure model (TPM). The user tests errors and exception data to determine whether the system responses are appropriate. Again, the user utilizes communications software 140 via the Internet 155 (or other network) to communicate with TeleShaper application 165, which in turn communicates with customer PC 172 to operate host application 175 via LAN 170.

Step 240: Validating that Input Fields Accept Correct “Special” Key Input

In this step, the user makes sure that special keystrokes work properly. For example, a particular step may be specified to accept an “F10” key to execute a command. The user tests these special keys to validate that the F10 key functions for that step and no others. This step takes place in the same system environment as described in steps 220 and 230 above.

Step 250: Ensuring Exit or Reset Process Works per each Input

In this step, the user tests that every input screen has an appropriate exit and reset response to a “master escape key.” The customer needs the ability to exit or abandon a data transaction in process. The master escape key allows immediate exit from both host application 175 and TeleShaper application 165, and it resets both applications to predetermined points in the program code. The user tests this capability to ensure that the appropriate code is in place and synchronized such that TeleShaper application 165 and host application 175 both return to an operational state. This step takes place in the same system environment as described in steps 220 and 230 above.

Step 260: Enhancing Data Transformation with Timeout Subroutine Call

In this step, the user tests a timeout subroutine to ensure the system can recover from unexpected data entries. A timeout subroutine is a module of programming that guides TeleShaper application 165 when the system is halted by untested, erroneous, or exception data. It serves to reset the system to be operational after the error occurs. This step takes place in the same system environment as described in steps 220 and 230 above.

Process 200 terminates after step 260.

An advantage of the present invention is that it ensures a prescribed standard of quality control has been met in a complete and efficient manner. The invention allows the QA testing process for a data transformation to be performed remotely. Another result of employing the invention is documentation of the QA testing, which may be required under regulatory programs of organizations and agencies such as ISO or FDA. The present invention is easily taught to QA personnel and is easily distributed throughout a customer organization.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A system for remotely validating a rule set, comprising:
a first computer adapted to accept test data and operating communications software, electrically connected to a server operating a trainable user interface translator application;
a remote customer site including the server electrically connected to a customer computer via a local area network, the customer computer operating a host application involved in a data transformation;
wherein a user uses the first computer and communication software to access the trainable user interface translator application to test the data transformation of the host application with test data by communicating with the customer computer via the local area network.

2. The system of claim 1, wherein the communications software is Procomm [symbol] .

3. The system of claim 1, wherein the first computer is electrically connected to the server via a network.

4. The system of claim 1, wherein the first computer is electrically connected to the server via the Internet.

5. A method of using a system to remotely validate a rule set, the system including a first computer adapted to accept test data and operating communications software, electrically connected to a remote customer site, the customer site further including a server operating a trainable user interface translator application and electrically connected via a local area network to a customer computer operating a host application involved in a data transformation, the method comprising the steps of:
receiving error, exception, and non-error and non-exception data for exercising the host application;
validating the data transformation by communicating the non-error and non-exception data from the first computer to the trainable user interface translator application in order to exercise the host application and to respond to the first computer;
validating that data transformation input fields meet design specifications by communicating the error and exception data from the first computer to the trainable user interface translator application in order to exercise the host application and to respond to the first computer;
validating that special keystrokes work properly by communicating special keystroke data from the first computer to the trainable user interface translator application in order to exercise the host application and to respond to the first computer;
ensuring that a master escape key entered on the first computer allows immediate exit from both the host application and the trainable user interface application, and resets both applications to a synchronized operational state; and
validating the performance of a timeout subroutine by halting the system by communicating untested, erroneous or exception data from the first computer to the trainable user interface translator application in order to exercise the host application and to respond to the first computer.
